(19) United States
(12) Patent Application Publication
(10) Pub. No.: US 2014/0062888 A1
(43) Pub. Date: Mar. 6, 2014

(54) SIGNAL PROCESSING DEVICE FOR A KEYBOARD AND SIGNAL PROCESSING METHOD THEREOF

(71) Applicants: PEGATRON CORPORATION, Taipei City (TW); Maintek Computer (Suzhou) Co., Ltd., Suzhou (CN)

(72) Inventors: Li-Jun Wen, Suzhou (CN); Chien-Jung Tu, TAIPEI CITY (TW); Li-Cheng Wang, Suzhou (CN); Jian Shen, Suzhou (CN); Meng-Chih Lin, TAIPEI CITY (TW)

(73) Assignees: PEGATRON CORPORATION, Taipei City (TW); Maintek Computer (Suzhou) Co., Ltd., Suzhou (CN)

(21) Appl. No.: 14/016,248

(22) Filed: Sep. 3, 2013

(30) Foreign Application Priority Data
Sep. 3, 2012 (CN) 201210321145.2

(51) Int. Cl. G06F 3/02

(52) U.S. Cl. CPC G06F 3/0213
USPC 345/168

(57) ABSTRACT

A signal processing device for a keyboard and a signal processing method thereof. The signal processing device for a keyboard includes a key scanning unit, a pointer rod scanning unit, an analog-to-digital conversion unit and a processing unit. The key scanning unit is connected with the keys for generating a first digital input signal. The pointer rod scanning unit is connected with the pointer rod for generating an analog input signal. The analog-to-digital conversion unit is connected with the pointer rod scanning unit and receives the analog input signal, and converts the analog input signal into a corresponding second digital input signal. The processing unit is connected with the key scanning unit and the analog-to-digital conversion unit for receiving the first digital input signal and the second digital input signal, and processes the first digital input signal and the second digital input signal by time sharing.

### BACKGROUND

1. Technology Field

The disclosure relates to a signal processing technique for a keyboard and, in particular, to a signal processing device for a keyboard and a signal processing method thereof.

2. Related Art

Some of the keyboards for notebook computers available in the market integrate pointer rods to simulate the function of a mouse. However, the signals of the keys on a keyboard and the signals of the pointer rod are processed by two processing modules respectively. Moreover, the signals of the pointer rod are often required to be processed by an ASIC (application-specific integrated circuit) to convert analog signals into PS/2 signal according to a protocol to control the cursor to move on a screen. This increases the overall complexity of the keyboard signal processing. For a computer manufacturer, manufacturing costs are increased due to the requirement of using the ASIC mentioned above.

### SUMMARY

In view of the above, an objective of the discolsure is to provide a signal processing device for a keyboard and the signal processing method thereof to prevent the use of a specific chip for the pointer rod signals and reduce the number of components and the manufacturing costs.

The signal processing device for a keyboard includes a key scanning unit, a pointer rod scanning unit, an analog-to-digital conversion unit and a processing unit. The key scanning unit is connected with the keys for generating a first digital input signal according to the status of the keys. The pointer rod scanning unit is connected with the pointer rod for generating an analog input signal according to the status of the pointer rod. The analog-to-digital conversion unit is connected with the pointer rod scanning unit and receives the analog input signal, wherein the analog-to-digital conversion unit converts the analog input signal into a corresponding second digital input signal. The processing unit is connected with the key scanning unit and the analog-to-digital conversion unit for receiving the first digital input signal and the second digital input signal. The processing unit processes the first digital input signal and the second digital input signal by time sharing.

The signal processing method for a keyboard is used to a keyboard having a plurality of keys and a pointer rod. The signal processing method for the keyboard includes the steps of generating a first digital input signal according to the status of the keys; generating an analog input signal according to the status of the pointer rod; converting the analog input signal into a corresponding second digital input signal; and processing the first digital input signal and the second digital input signal by time sharing.

The disclosure uses the same processing unit to process the first digital input signal corresponding to the keys and the second digital input signal corresponding to the pointer rod by time sharing. The use of a specific chip is prevented, whereby the processing complexity is reduced, the number of components is reduced, and the manufacturing costs are also reduced.

### BRIEF DESCRIPTION OF THE DRAWINGS

FIG. 1 is a functional block diagram of the signal processing device of the keyboard according to a preferred embodiment of the invention.

FIG. 2 is a schematic timing diagram of the signal processing of the keyboard according to a preferred embodiment of the invention.

FIG. 3 is timing diagram of the signal variation along the x-axis or the y-axis.

FIG. 4 is a flowchart of the signal processing method of the keyboard according to a preferred embodiment of the invention.

FIG. 5 is a flowchart of the signal processing method of the pointer rod according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

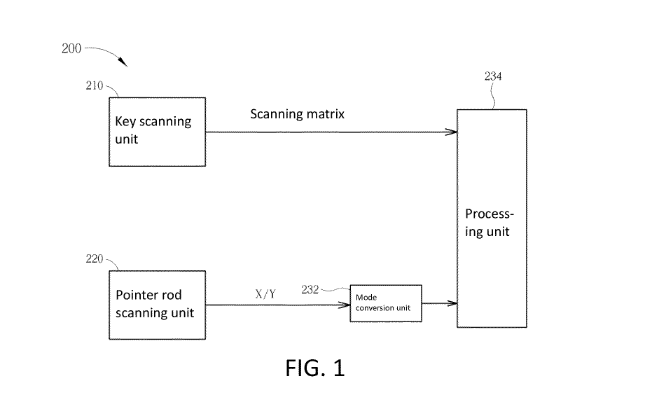

FIG. 1 is a functional block diagram of the signal processing device for a keyboard according to a preferred embodiment of the invention. The signal processing device 200 for the keyboard of the present embodiment is connected with a keyboard to process the signals of the keyboard. Here, the keyboard has a plurality of keys and a pointer rod. The keys are used to input information such as texts, and the pointer rod is used to control the cursor to move on a screen. In the present embodiment, as shown in FIG. 1, the signal processing device 200 includes a key scanning unit 210, a pointer rod scanning unit 220, an analog-to-digital conversion unit 232, and a processing unit 234. The key scanning unit 210 is connected with a plurality of keys. The pointer rod scanning unit 220 is connected with the pointer rod. The analog-to-digital conversion unit 232 is connected with the pointer rod scanning unit 220. The processing unit 234 is connected with the key scanning unit 210 and the analog-to-digital conversion unit 232.

In the present embodiment, the key scanning unit 210 generates a first digital input signal according to the status of the key. Here, the keyboard may be an 8×16 matrix keyboard, and therefore the key scanning unit 210 may be a scanning unit for an 8×16 keyboard matrix. However, the invention is not limited therein. The keyboard may also be an 8×8 matrix keyboard, and the key scanning unit 210 may be correspondingly a scanning unit for an 8×8 keyboard matrix.

In the present embodiment, the pointer rod scanning unit 220 generates an analog input signal according to the status of the pointer rod. The analog-to-digital conversion unit 232 receives the analog input signal, and converts the analog input signal into a corresponding second digital input signal.

In the present embodiment, the processing unit 234 receives the first digital input signal and the second digital input signal. The processing unit 234 may process the first digital input signal and the second digital input signal by time sharing. The processing unit 234 may generate a corresponding key input according to the first digital input signal, and controls the cursor to move on the screen according to the second digital input signal.

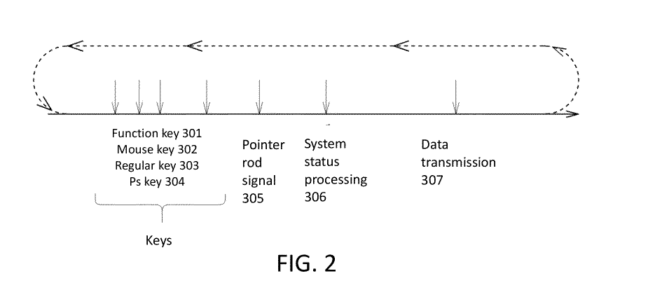

Please refer to FIG. 2 and FIG. 1 simultaneously. FIG. 2 is a schematic timing diagram of the signal processing of the keyboard according to a preferred embodiment of the invention. As shown in FIG. 2, the processing unit 234 processes a key signal (that is, the first digital input signal) in a first time slot within a scanning period (such as 25 milliseconds). Here, the key signal may include the signal of a function key 301 (such as F1 to F12 keys), a mouse key 302 (such as direction keys of up, down, left and right), a regular key 303 (such as alphabet keys of A to Z), and Ps key 304. However, the invention is not limited therein. In other embodiments, the key signals may only include a portion of the key signals mentioned above. Subsequently, the processing unit 234 may start to process a pointer rod signal 305 (that is, the second digital input signal) in a second time slot within the scanning period and continue the system status processing 306 and the data transmission 307 after the processing of the pointer rod signal 305 is completed. The processing unit 234 performs the signal processing periodically based on the timing sequence mentioned above. However, the invention is not limited to the time sequence of the signal processing of the processing unit 234. In other embodiments, the processing unit 234 may also process the pointer rod signal 305 in the first time slot and process the key signal in the second time slot. The procedure of how the processing unit 234 processes the pointer rod signal 305 will be described below.

In the present embodiment, when the processing unit 234 processes the pointer rod signal 305 (that is, the second digital input signal) in the second time slot (for example, a preset time of 3 milliseconds) of the scanning period, the processing unit 234 performs samplings to the second digital input signal generated by the conversion of the analog-to-digital conversion unit 232 with a certain frequency to obtain a plurality of second digital input signals. For example, if the user does not operate the pointer rod within a period of time, the signals sampled by the processing unit 234 may be 00000000. If the user pushes the pointer rod, the signals sampled by the processing unit 234 may be varied correspondingly based on the direction and distance the user pushes the pointer rod, such as 01001000 for example. The invention is not limited therein. Subsequently, the processing unit 234 may average a plurality of the second digital input signals to obtain a first average value, and then correspondingly output a pointer rod signal variation amount in the last slot of a scanning period to control the cursor to move toward a corresponding direction on the screen. For example, the processing unit 234 may perform sampling 10 times within the preset time of 3 milliseconds, and use the average of these 10 samples as the output of the pointer rod signal variation amount. Moreover, to improve accuracy, after sampling 10 times, the processing unit 234 may calculate the average after removing the samples with the largest and smallest values to output the pointer rod signal variation amount. However, the invention is not limited therein.

In other embodiments, to further improve control accuracy, the processing unit 234 may sample multiple sets of second digital input signals in the second time slot, calculate the average of each set of second digital input signals, remove the largest and smallest averages, and finally calculate the average of the averages of the remaining sets to output it as the pointer rod signal variation amount. For example, the processing unit 234 may sample 10 sets of data within the preset time of 3 milliseconds, with each set containing 8 samples. The average of the 8 sample is calculated and used as the second digital input signal of that set, and the calculation is repeated to obtain 10 averages of the 10 sets. Afterwards, the largest and smallest averages are removed, and the average of the remaining 8 averages of the 8 sets is output as the pointer rod signal variation amount.

Moreover, in the present embodiment, after calculated the first average value, the processing unit 234 may refer to a reference value to obtain a pointer rod signal variation amount. That is, the processing unit 234 does not output the absolute value of the calculated first average value as the pointer rod signal variation amount, but output the difference between the first average value and the reference value as the pointer rod signal variation amount. If the absolute value of the difference between the first average value and the reference value is smaller than or equal to a first value, for example the difference between the first average value and the reference value is within the range of ±2 bits, it is determined that no operation is performed on the pointer rod and the cursor does not need to move. However, the invention does not limit the magnitude of the first value, which can be set in view of different practical applications.

It is noteworthy that the second digital input signal substantially includes input signals on the X axis and the Y axis. The procedure of the processing unit 234 mentioned above is applicable to both the second digital input signals on the X axis and the Y axis.

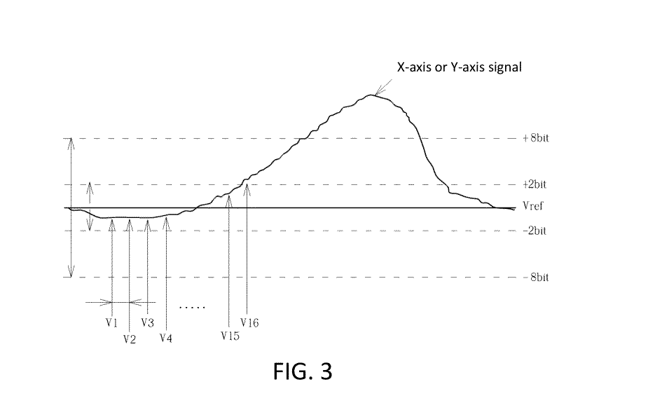

Furthermore, in the present embodiment, since the second digital input signals on the X axis and the Y axis may drift over time, to prevent the move of the cursor on the screen due to the drift of the X axis and the Y axis signals, the processing unit 234 performs a calibration to the reference values of the X axis and the Y axis every fixed time interval (such as 6 seconds), and the reference values after calibrated are the second average values of the multiple second digital input signals on corresponding directions within the fixed time interval. Please refer to FIG. 3, which is a timing diagram of the signal variation along the x-axis or the y-axis. The processing unit 234 determines whether the reference value (Vref) needs to be calibrated according to the second digital input signal on the X axis and the second digital input signal on the Y axis. For example, when the absolute value of the difference between the second average value (the average of V1 to V16) and the reference value exceeds a second value (for example, the difference between the second average value and the reference value exceeds the range of ±8 bits), it should be determined that the user operated the pointer rod within this fixed time interval. If the calibration is performed to the reference value at this moment, the cursor on the screen will stop and an error will be occurred. Therefore, under this circumstance, the processing unit 234 will not perform a calibration to the reference value. When the absolute value of the difference between the second average value and the reference value is smaller than or equal to the second value (that is, the difference between the second average value and the reference value is within the range of ±8 bits), and the largest one of the absolute values of the differences between the multiple second digital input signals (V1 to V16) and the second average value is smaller than the first value (that is, take the absolute value of each second digital input signal subtracted by the second average value first, and then the largest one of the absolute value taken is smaller than 2 bits), it should be determined that the user did not operate the pointer rod within this fixed time interval. The calibration can be performed to the reference value at this moment, and the calibrated reference value is the second average value (the average of V1 to V16). The invention has no limitation regarding the value of the fixed time interval and the second value, which can be determined in view of required control accuracy and practical applications.

Furthermore, it should be mentioned that the sample values V1 to V16 in FIG. 3 may represent the sample values of the second digital input signals obtained by the processing unit 234 every time interval, or the averages of multiple samples of the second digital input signals obtained by the processing unit 234 every time interval. The invention is not limited therein.

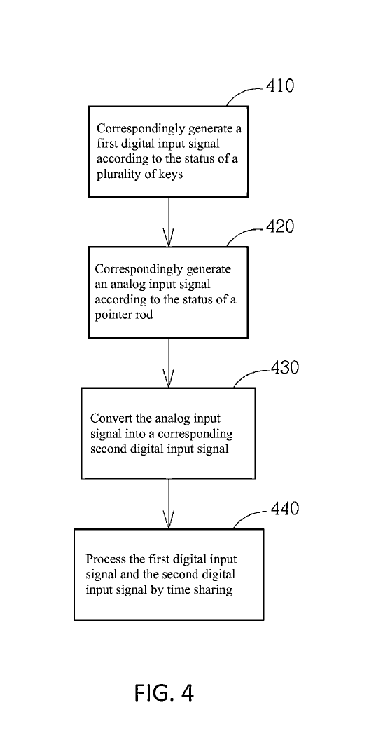

Please refer to FIG. 4. FIG. 4 is a flowchart of the signal processing method of the keyboard according to a preferred embodiment of the invention. The process of the signal processing method of the keyboard includes the following steps:

Step 410: correspondingly generating a first digital input signal according to the status of a plurality of keys;

Step 420: correspondingly generating an analog input signal according to the status of a pointer rod;

Step 430: converting the analog input signal into a corresponding second digital input signal; and

Step 440: processing the first digital input signal and the second digital input signal by time sharing.

The invention does not limit the sequence of the first digital input signal and the second digital input signal.

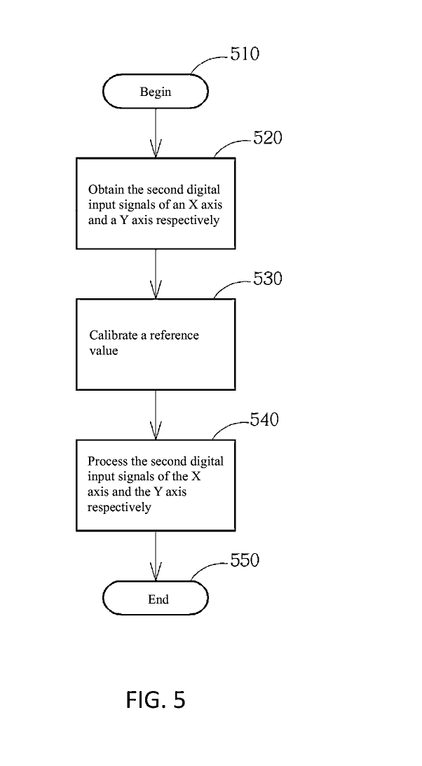

Please refer to FIG. 5. FIG. 5 is a flowchart of the signal processing method of the pointer rod according to a preferred embodiment of the invention. The process of the signal processing method of the pointer rod includes the following steps:

Step 510: begin;

Step 520: obtaining the second digital input signals of an X axis and a Y axis respectively;

Step 530: calibrating a reference value;

Step 540: processing the second digital input signals of the X axis and the Y axis respectively; and

Step 550: end.

Through the processing method mentioned above, the preferred embodiment of the invention realizes the usage of the same processing unit to perform time-sharing processing to the signals of the keyboard and the signals of the pointer rod. It is not necessary to use a specific chip to process the signals of the pointer rod. Therefore, the invention reduces the overall complexity of the signal processing of the keyboard integrated with a pointer rod. For computer manufacturers, manufacturing costs are reduced since it is not necessary to process the signals of the pointer rod using a specific chip.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A signal processing device for a keyboard connected with the keyboard, the keyboard having a plurality of keys and a pointer rod, the signal processing device comprising:
a key scanning unit connected with the keys for generating a first digital input signal according to the status of the keys;
a pointer rod scanning unit connected with the pointer rod for generating an analog input signal according to the status of the pointer rod;
an analog-to-digital conversion unit connected with the pointer rod scanning unit and receiving the analog input signal, the analog-to-digital conversion unit converting the analog input signal into a corresponding second digital input signal; and
a processing unit connected with the key scanning unit and the analog-to-digital conversion unit for receiving the first digital input signal and the second digital input signal, the processing unit processing the first digital input signal and the second digital input signal by time sharing.

2. The signal processing device for the keyboard according to claim 1, wherein
the processing unit processes the first digital input signal in a first time slot of a scanning period, and processes the second digital input signal in a second time slot of the scanning period.

3. The signal processing device for the keyboard according to claim 1, wherein
when processing the second digital input signal, the processing unit obtains a plurality of the second digital input signals within a preset time and calculates a first average value, the processing unit obtains a pointer rod signal variation amount according to the first average value to control a cursor to move on a screen according to the pointer rod signal variation amount.

4. The signal processing device for the keyboard according to claim 3, wherein
the processing unit obtains the pointer rod signal variation amount according to the first average value while referring to a reference value.

5. The signal processing device for the keyboard according to claim 4, wherein
the processing unit performs a calibration to the reference value every fixed time interval, the reference value calibrated is the second average value of the plurality of second digital input signals within the fixed time interval.

6. The signal processing device for the keyboard according to claim 5, wherein
when the largest of the absolute values of the differences between the plurality of second digital input signals within the fixed time interval and the second average value is smaller than a first value, and the absolute value of the difference between the second average value and the reference value is smaller than or equal to a second value, the processing unit performs the calibration to the reference value, wherein the second value is larger than the first value.

7. A signal processing method for a keyboard used to the keyboard, the keyboard having a plurality of keys and a pointer rod, the signal processing method for the keyboard comprising the steps of:
generating a first digital input signal according to the status of the keys;
generating an analog input signal according to the status of the pointer rod;
converting the analog input signal into a corresponding second digital input signal; and
processing the first digital input signal and the second digital input signal by time sharing.

8. The signal processing method for the keyboard according to claim 7, wherein the step of processing the first digital input signal and the second digital input signal by time sharing comprises:
processing the first digital input signal in a first time slot of a scanning period; and
processing the second digital input signal in a second time slot of the scanning period.

9. The signal processing method for the keyboard according to claim 7, wherein
when processing the second digital input signal, the processing unit obtains a plurality of the second digital input signals within a preset time and calculates a first average value, the processing unit obtains a pointer rod signal variation amount according to the first average value to control a cursor to move on a screen according to the pointer rod signal variation amount.

10. The signal processing method for the keyboard according to claim 9, wherein
the pointer rod signal variation amount is obtained according to the first average value while referring to a reference value.

11. The signal processing method for the keyboard according to claim 10, wherein
a calibration is performed to the reference value every fixed time interval, the reference value calibrated is the second average value of the plurality of second digital input signals within the fixed time interval.

12. The signal processing method for the keyboard according to claim 11, wherein
when the largest of the absolute values of the differences between the plurality of second digital input signals within the fixed time interval and the second average value is smaller than a first value, and the absolute value of the difference between the second average value and the reference value is smaller than or equal to a second value, the calibration is performed to the reference value, wherein the second value is larger than the first value.
